(19) United States
(12) Patent Application Publication
(10) Pub. No.: US 2023/0076467 A1
(43) Pub. Date: Mar. 9, 2023

(54) Intermediary, Digital, Data-Driven Platform for Standardised Linking of Complex Industrial Ecosystems and Risk Transfer Technology Ecosystems and Corresponding Processes

(71) Applicant: Swiss Reinsurance Company Ltd., Zurich (CH)

(72) Inventor: Jan KANDERAL, Zurich (CH)

(73) Assignee: Swiss Reinsurance Company Ltd., Zurich (CH)

(21) Appl. No.: 18/049,115

(22) Filed: Oct. 24, 2022

Related U.S. Application Data
(63) Continuation of application No. PCT/EP2021/077382, filed on Oct. 5, 2021.

(30) Foreign Application Priority Data
Oct. 5, 2020 (CH) 01261/20

(51) Int. Cl. G06Q 40/08

(52) U.S. Cl. CPC G06Q 40/08

(57) ABSTRACT

An intermediary, digital, data-driven platform and procedures for heterogeneous industrial ecosystems for the standardised recording and automated management of risk transfers and assigned product- and company-specific capacities as a standardised digital channel between risk-exposed units of the industrial ecosystem and the systems of a heterogeneous risk transfer ecosystem.

### CROSS REFERENCE TO RELATED APPLICATIONS

The present application is a continuation of International Patent Application No. PCT/EP2021/077382, filed Oct. 5, 2021, which claims priority to Swiss Application No. 01261/20, filed Oct. 5, 2020, the contents of each of which are hereby incorporated by reference in their entirety.

### FIELD OF THE INVENTION

The present invention relates to an automated digital channel and digital platform for automated parameter-driven, scenario-based risk transfer underwriting, risk determination, classification and risk transfer/portfolio management for standardised risk transfer in the case of heterogeneous risk sources and risk exposure classes. In particular, the present invention relates to digital, risk transfer technology-related digital platforms that provide digitally enabled, data-driven services and risk transfer solutions that enable a standardised link between industrial ecosystems, in particular machine technology ecosystems and risk transfer technology ecosystems, and provide the appropriate technical means to connect the two ecosystems. The invention also relates to embodiments for digital platforms that provide at least one automated digital channel that is provided by the automated digital platform for risk-exposed units that access the digital platform with the aid of network-compatible devices via a data transmission network. In addition, the present invention relates to intelligent, automated and optimised technologies for interactive control by means of specifically selected, self-optimising, machine-based intelligence, monitoring and adaptation/optimisation when connecting the two complex ecosystems with specifically technically selected measurement, control- and signalling parameters. It also relates to systems for the automation and machine-driven optimisation of one or more digital underwriting, quoting, pricing and risk management channels related to the provision of an automated risk transfer and the control and signalling of risk portfolios, which interactively enable an improved composition and configuration of risk transfer solutions for a user.

### BACKGROUND OF THE INVENTION

The invention relates to the technical field of digital platforms that provide digital, data-driven services, risk transfer solutions and collaborations between complex industrial ecosystems and risk transfer technology ecosystems. In order to provide risk transfer solutions to customers in industry ecosystems, it is usually necessary to involve experts with different roles for the use and development of skills. In complex, heterogeneous industrial ecosystems, this leads to an exponentially growing coordination, communication and processing effort for the implementation of new risk transfer products, and automated risk coverage and functions, which hinders the scalability and agility of insurance systems.

The automation and interactive control of risk transfer processes is complex and technically extremely demanding, especially when the risk exposers are linked to a pool of different assets and risks. There are many reasons for this, such as automated prediction and quantitative measurement of the probability of occurrence, i.e. the measurement of quantifiable risks or risk exposure of an object on the basis of measured physical parameters, i.e. in relation to the current or future occurrence of physical events, in particular damaging events (events with a measurable, physical effect on an object). In this application, risk and risk measure are understood as a measurement unit (quantity) that can be physically measured using technical means. The risk measurement unit can be specified in the units % or as a value between 0 and 1, with 1 denoting a 100% probability of occurrence of the measurable event for the current or a future time window, wherein the probability of occurrence is the averaged frequency of occurrence for such a measurement event in the physical time window, i.e. repeatedly measurable and quantified with technical means. Another reason is, for example, the difficult-to-measure interrelationship between the actually occurring and measurable physical impact strength and the physical strength of the physical event (also referred to here as a risk event). Therefore, the technical challenges for the automated determination, monitoring and control of suitable risk transfer parameters are diverse, wherein the risk transfer parameters define the portion of the risk that is typically balanced and transferred in exchange for monetary parameter values as part of an underwriting process. The automated generation of coverage offers based on physical measurement parameters, which is based on the parameters mentioned above, is technically complex.

U.S. Pat. No. 9,830,663B2 shows a platform that makes it possible to determine an insurance rating on the basis of an industry classification. The platform receives search data relating to the unit searching for insurance coverage and queries an interface of a third-party platform on the basis of the search data. The system then receives the interface data of a third-party platform from the third-party platform, analyses the data relating to the entity, and retrieves the data from the third-party platform on the third-party platform that indicates content relating to the entity. As an alternative to the variant described in U.S. Pat. No. 9,830,663B2, the inventive system can be designed in such a way that the third-party provider leaves the calculation logic (e.g. premium tables, validation rules, etc.) to the system, wherein the third-party provider's risk transfer product is reproduced in the system. This may be necessary if the third party provider does not have the technical opportunities to query data (e.g. a specific price) in real time. On the basis of the interface data from the third-party platform and the location data, the system outputs initial data which indicate at least one industry classification associated with the entity. WO2019195725A1 discloses an underwriting and risk management platform that uses machine learning to enable decision making and risk assessment. Predictive analytics using advanced data sets can provide insightful data that can be used for insurance underwriting and usable information for stakeholders. US866086864B2 shows another digital platform for underwriting using data from social networks. The platform comprises an automated platform for risk transfer underwriting to evaluate and rate insurance policies by accessing and evaluating community, social and business network-based information. Community or social network rating data is analysed and weighting factors are applied to the community or social network rating data. An underwriting decision is then transmitted for the unit potentially to be insured, which is based at least in part on the rating data of the community or the social network. WO2019144035A1 shows a system that generally collects, organizes, processes and analyses internal and alternative data sources for the benefit of a broad spectrum of operating activities of insurance companies, including an insurance data platform that uses data from non-traditional, alternative data sources in order to generate a business risk score from web data that provides a unique insurance-related insight into the business that cannot be determined using traditional models.

### SUMMARY OF THE INVENTION

The object of the invention is to provide a technical platform, in particular a digital platform, which forms a digital link and connection with industrial ecosystems and risk transfer technology ecosystems (see FIG. 2), in particular to manage such industrial risks as a digital orchestrator platform for risk transfer providers. The digital platform is intended to automate a scalable, systematic recording, measurement, quantification and forward-looking (predictive) generation of suitable quantitative risk and risk accumulation units of measurement for risk transfers and risk transfer portfolios and to provide the appropriate technical means associated with the risk exposure of physical real units of the industrial and technology ecosystem on the basis of physically measurable measurement parameter values and data, i.e. the effects of a possibly occurring physically measurable event in a defined future time window. Another object of the present invention is to propose a processor-driven system and digital platform which provides an automated digital channel for the automatic conclusion and dynamic adaptation of risk transfers between units of risk transfer ecosystems and units of industrial ecosystems and that does not have the disadvantages of the known systems. In order to provide a technical solution, it is necessary to include a wide variety of roles in the use and implementation of the digital system/channel as an expert system. In smaller teams with qualified employees, it is still possible for one person to have multiple roles. As the process and functionalities increase in size, the roles are filled by individuals. This leads to an exponential increase in the coordination, communication and processing effort for the implementation of new products and functions, which prevents scalability and agility from being achieved. The present digital system has the object of solving these disadvantages by means of technical means. Another object of the present invention is to provide a processor-driven, digital platform which comprises a user interface which is accessible to users with the aid of terminals via a data transmission network, which comprises data entry fields for entering data relating to the object of a risk transfer, which is available as a single, continuous process for the implementation, monitoring and adaptation of risk transfers or portfolios of risk transfers and can be used by the user regardless of the location or the desired object of a risk transfer. The quantitative risk measurement should make it possible to record different device and environmental structures of complex industrial ecosystems, whereby a precise and reproducible measurement of risk factors is made possible and the effects of the risk events on the occurrence of the associated events can be optimised.

According to the present invention, these objects are achieved in particular with the features of the independent claims. In addition, further advantageous embodiments can be derived from the dependent claims and the associated descriptions.

According to the present invention, the above-mentioned objects for an intermediary, digital, data-driven platform for industrial ecosystems for the quantised recording, provision, measurement and automated management of risk transfers and/or automated risk transfer orchestration as a digital, standardised link or digital, standardised channel between risk event-exposed units of the industrial ecosystem and the risk transfer ecosystem in fragmented, heterogeneous data environments, in particular to cover effects on the event-exposed units caused by defined, future occurring, physical events as a source of risk, are achieved in that the probability of the future occurrence of one of the defined physical events comprises heterogeneous risk classes and risk segments, and the intermediary platform as a standardised digital channel links the event-exposed units and the risk transfer systems by means of the risk transfers, so that by means of the digital platform, the risk transfers with assigned risk transfer parameters and assigned premium parameters for the heterogeneous risk classes and risk segments based on recorded user- or exposure-specific data are provided in a standardised and automated manner and are stored as risk transfer portfolio data assigned to a portfolio in a persistence memory of the digital platform, wherein the risk transfer portfolio data of a risk transfer comprise at least one allocated link between a risk source, a risk exposure measure and an event-exposed asset of an event-exposed unit, and wherein, based on the assigned premium parameters, premiums are transferred to the digital platform or the risk transfer systems for carrying out the risk transfer, so that if one of the defined events and one of the effects that can be assigned to the event occurs on one of the event-exposed assets of the risk transfer portfolio data, damage parameters are recorded in a standardised manner by means of the digital platform, wherein, by means of the recorded damage parameters, a damage coverage for effects generated by the occurring defined event based on the risk transfer parameters is automatically triggered by means of the system and is transferred to the event-exposed unit.

The digital platform has, inter alia, the advantage that it allows a digital, standardised channel to be provided as a technical platform for digital markets for heterogeneous industrial ecosystems in order to cover and manage their various risks in an automated and optimised manner as an automated risk transfer orchestrator. In order to be able to provide a customer, i.e. a risk-exposed unit of the industrial ecosystem, with risk coverage by means of risk transfer solutions, at least five roles listed below must be included. In the prior art, in smaller teams with qualified employees, it is possible for one person to hold multiple roles. However, when the risk coverage process and the functionalities become larger, the roles must be filled by individuals. In the case of even larger processes, this leads to an exponential increase in the coordination, communication and processing effort for the implementation of new risk transfer structures and functions, which, apart from the necessary manual processing, prevents scalability and agility from being achieved. The roles include (i) client (risk-exposed entity), (ii) underwriter, (iii) developer, (iv) tester, and (v) risk taker, i.e. a risk transfer system or insurance system. DevOps can, for example, be used to optimise and improve the cooperation between risk transfer structure development and risk transfer operation through the risk transfer system. That means DevOps to produce the quality of the structure provided, the speed of development and delivery. The first two roles (i) and (ii) can be assigned to the “use capability” layer, while the last three roles (iii), (iv) and (v) can be assigned to the “build capabilities” layer. The risk taker belongs to the “build capabilities” layer, since a special risk transfer product often has to be designed. To avoid the above-mentioned problems, the inventive structure allows the development of skills for risk transfer to be technically separated from the use of skills for risk transfer. The proposed solution allows clients from the industrial ecosystem and solution designers to orchestrate the functions provided for customer-specific use cases on the basis of the inventive workflow engine. Risk transfer providers and IT engineers can jointly develop agnostic skills, e.g. creating certificates, First Notice of Loss (FNOL) on the mobile phone, processing bordereaux payments, etc. With the inventive, intermediary, digital platform, damage claims can be reported (First Notice of Loss, FNOL) by email, short message system (SMS) or other short message services, telephone or online on the claims portal. The incoming messages are collected centrally and automatically forwarded to the various modules for further processing. Due to having to be done manually in the prior art, this was inefficient and led to long processing times if the assignment was incorrect or the teams were overloaded. The present invention allows a machine-learning unit of the digital platform to be trained on a cleaned database, for example based on a supervised learning structure. In this way, the inventive system recognises the various types of damage and generates corresponding messages independently or automatically carries out the corresponding triage. A feedback loop can be used, for example, to provide feedback on whether the case has been correctly forwarded. This feedback flows directly into the calibration of the algorithm. With the inventive system, the assignment of claims is therefore fully automatic. The distribution of messages is therefore more precise and much faster than in the manual process. The system learns with every risk transfer and damage coverage carried out and improves continuously.

### BRIEF DESCRIPTION OF THE DRAWINGS

The present invention is explained in more detail using an example with reference to the drawings in which it is illustrated:

FIGS. 1-12 show diagrams for the schematic representation of an exemplary digital platform 1, in particular specific embodiments relating to different categories of industrial ecosystems, such as: (i) logistics: spot cover as a standard risk transfer offered to every participant in the market platform and open cover as a pre-agreed framework agreement with a specific participant in the market platform; (ii) aviation: event coverage against flight delays and extended warranties for airlines based on framework agreements; (iii) trade credits: orchestrated trade credit risk transfer between multiple risk transfer providers (insurance companies); (iv) machinery and equipment: event-driven insurance protection against unexpected machine failures for manufacturers based on framework agreements; and (v) parametrics: parametric coverage against Nat-Cat (natural catastrophe events) for companies or individuals.

FIG. 2 shows a schematic diagram that illustrates the digital, standardised linkage by means of the inventive digital market platform, which forms the aforementioned digital, electronic and standardised link and connection between the industrial ecosystems and risk transfer technology ecosystems. In particular, the digital platform allows heterogeneous risk transfer embodiments of different categories of industrial ecosystems and sources of risk to be provided in a standardised manner, such as: (i) logistics: spot cover as a standard risk transfer offered to every participant in the market platform and open cover as a pre-agreed framework agreement with a specific participant in the market platform; (ii) aviation: event coverage against flight delays and extended warranties for airlines based on framework agreements; (iii) trade credits: orchestrated trade credit risk transfer between multiple risk transfer providers (insurance companies) including Corso (corporate solutions); (iv) machinery and equipment: event-driven insurance protection against unexpected machine failures for manufacturers based on framework agreements; and (v) parametrics: parametric coverage against Nat-Cat (natural catastrophe events) for companies or individuals.

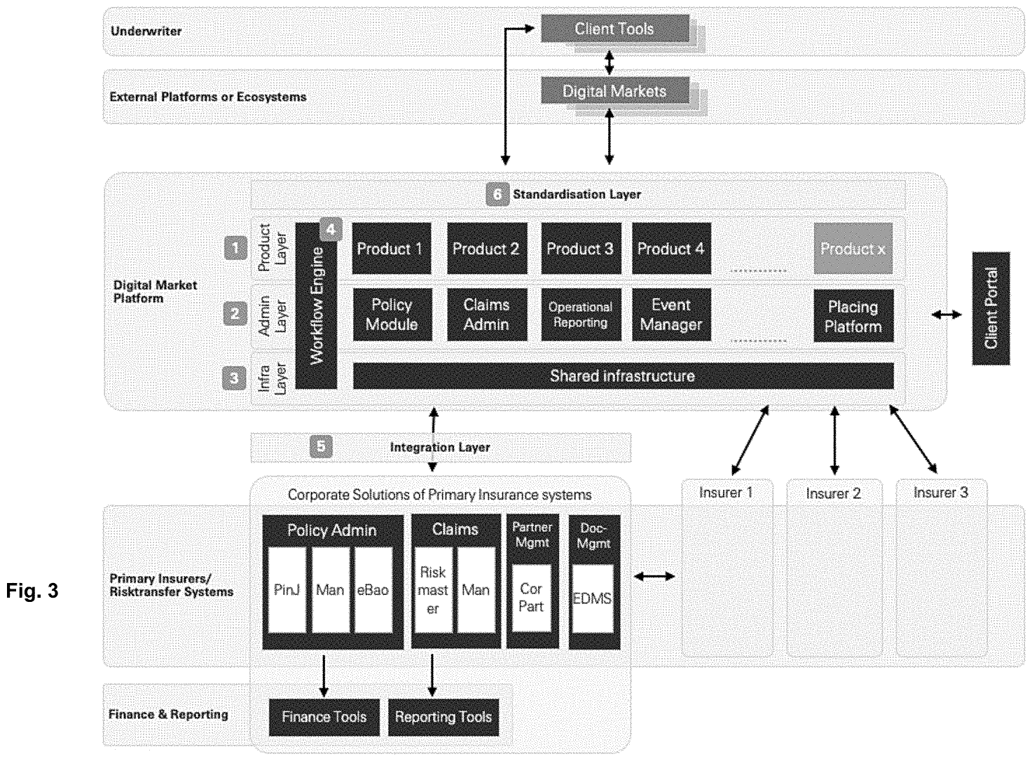

FIG. 3 shows an example of a block diagram which schematically illustrates the structure and architecture of an intermediary, digital, event-driven platform 1 for a digital market as a parametric insurance platform. In this exemplary embodiment, the platform is structured in three logical layers and further components such as the workflow engine 114:
Products layer 111 ([1]): configuration of a specific product or risk transfer structure 1111, 1112, 1113, 1114, . . . , 111i (e.g. freight spot trip, airline delay insurance, C&S, etc.) The risk transfer structure 1111, 1112, 1113, 1114, . . . , 111i can be based on simple rate tables up to highly complex dynamic calculations.
Administration layer 112 ([2]): offers functions that are product-independent and generic. The functions are structured specifically for the risk taker.
Infrastructure layer 113 ([3]): offers IT platform functionalities 1131 such as security functions 11311, monitoring functions 11312, etc. The functionalities can, for example, be used together with a reinsurance system.
Workflow engine 114 ([4]): the process for the individual use cases is configured in the workflow engine 114 using the capacities of the build 1126 by the product and administration layer 111/112.
API integration layer 115 ([5]): common integration layer for company-specific backend applications.
Standardisation layer 116 ([6]): translation of the external data language into the standard risk taker language to enable the re-usability of skills

As an implementation principle, it should be noted that the standard process is automated and only handles exceptions manually. Capacities 1111/1126 consist of process and system functionality. They are encapsulated and set up independently of one another. They also have a defined input parameter with defined output parameters. This ensures scalability and agility.

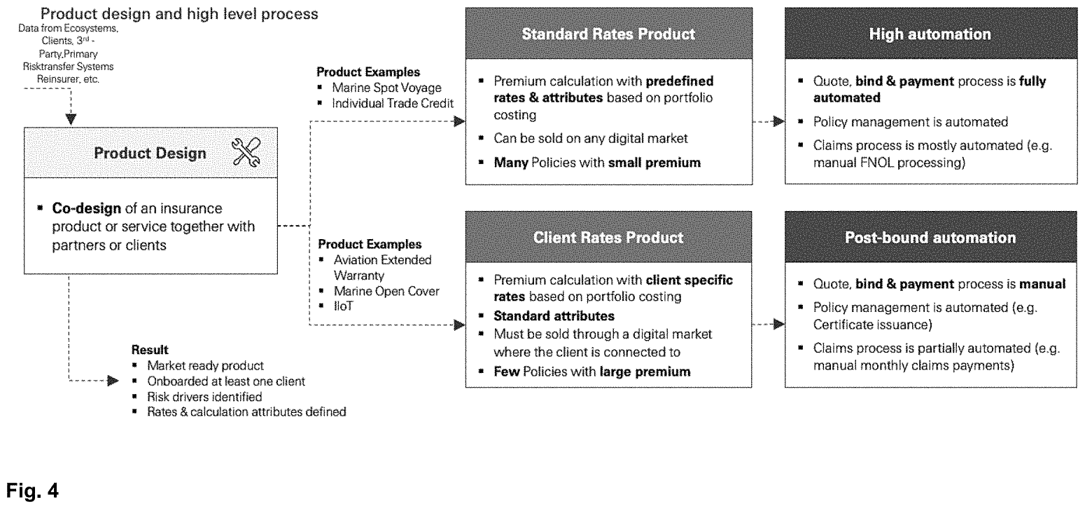

FIG. 4 shows an example of a block diagram which schematically shows the processes of risk transfer design or provision by means of the intermediary, digital platform 1, as well as associated high-level processes.

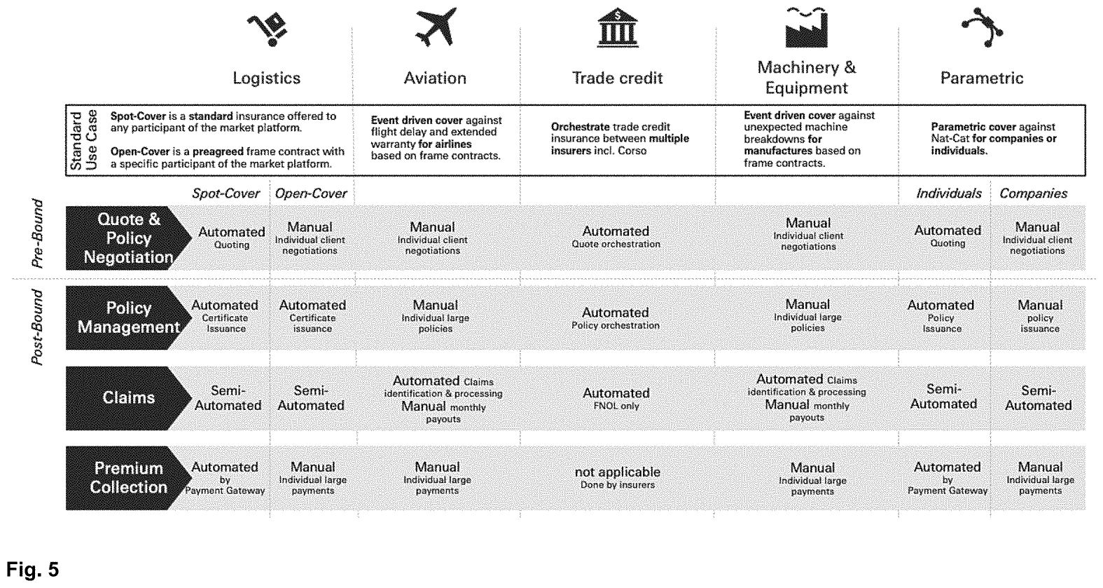

FIG. 5 shows an example of a block diagram which schematically shows the process steps by means of the intermediary, digital platform 1. Depending on the application, it may not necessarily make sense to automate certain process steps. This can, for example, apply to sectors in which large individual risk transfers are provided (e.g. aviation and IIoT).

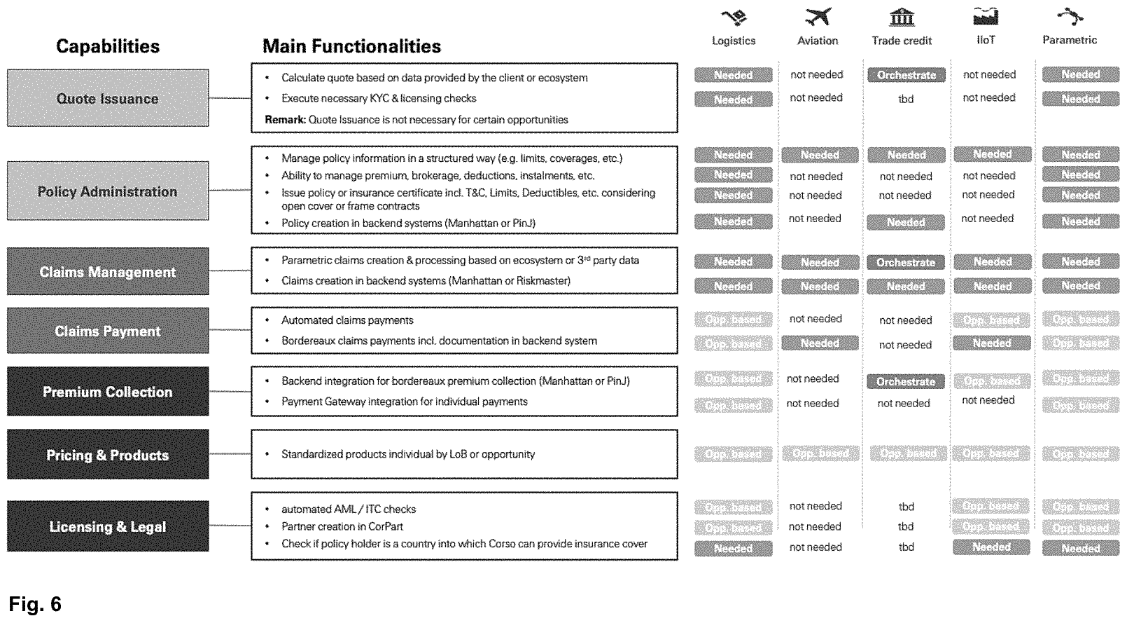

FIG. 6 shows an example of a block diagram which schematically shows the capacities 1126 with the encapsulated and independently constructed process and system functionalities (“main functionalities”).

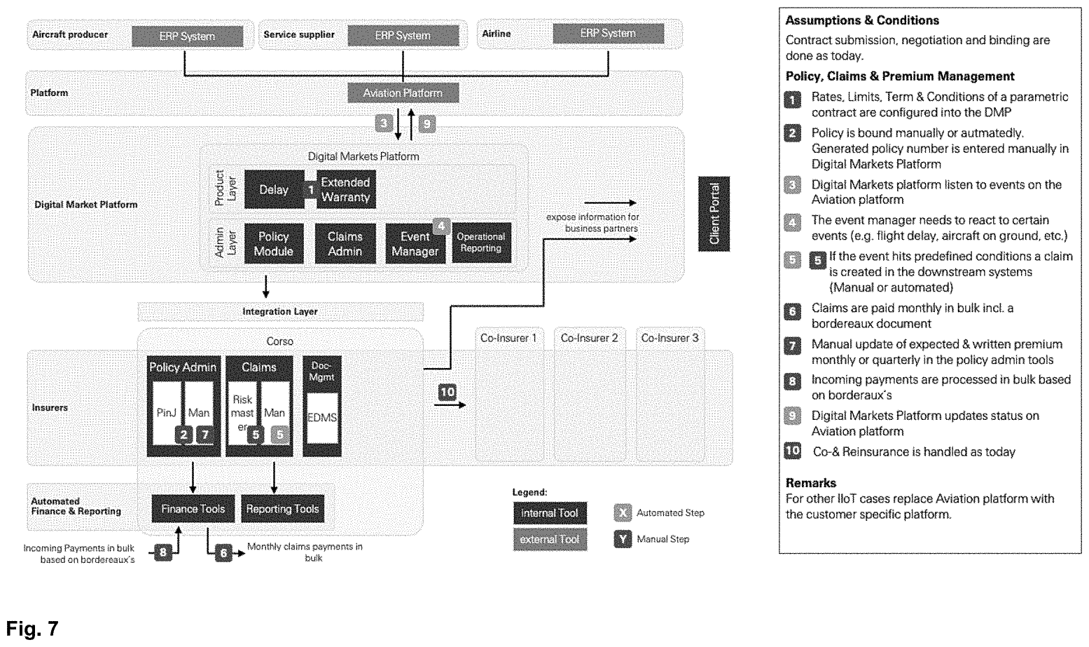

FIG. 7 shows an example of a block diagram which schematically illustrates a structure and architecture of an intermediary, digital, event-driven platform 1 for a digital market as a parametric insurance platform, as shown in FIG. 3, in an embodiment adapted to aviation and IIoT risk sources or risk events 10i11.

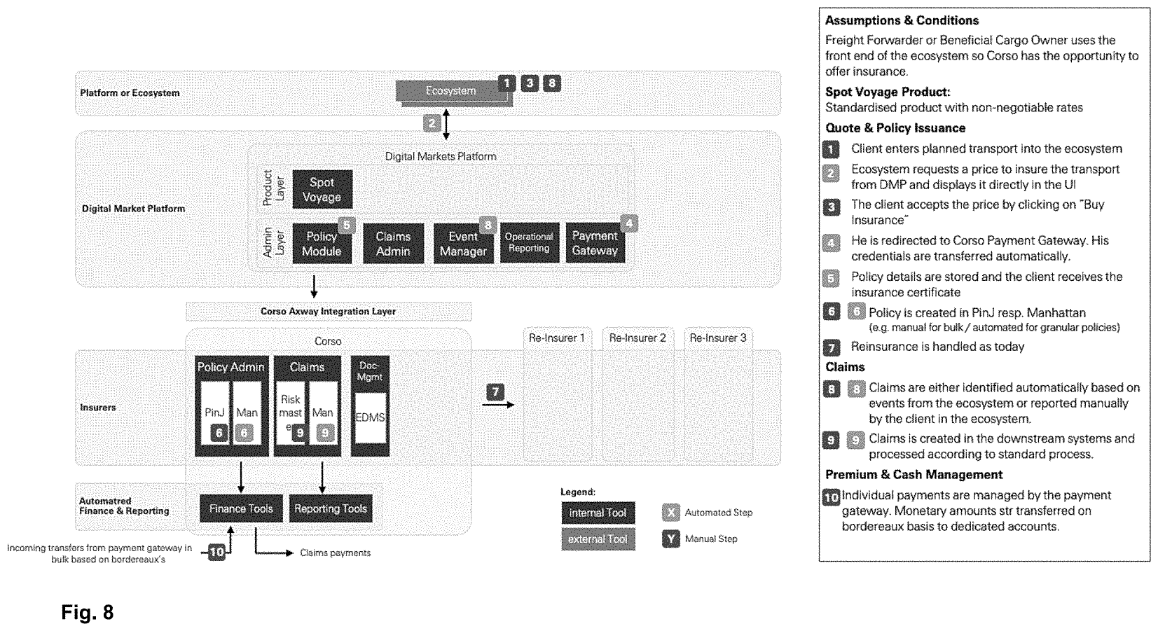

FIG. 8 shows an example of a block diagram which schematically illustrates a structure and architecture of an intermediary, digital, event-driven platform 1 for a digital market as a parametric insurance platform, as shown in FIG. 3, in an embodiment adapted to marine cargo risk sources or risk events 10i11.

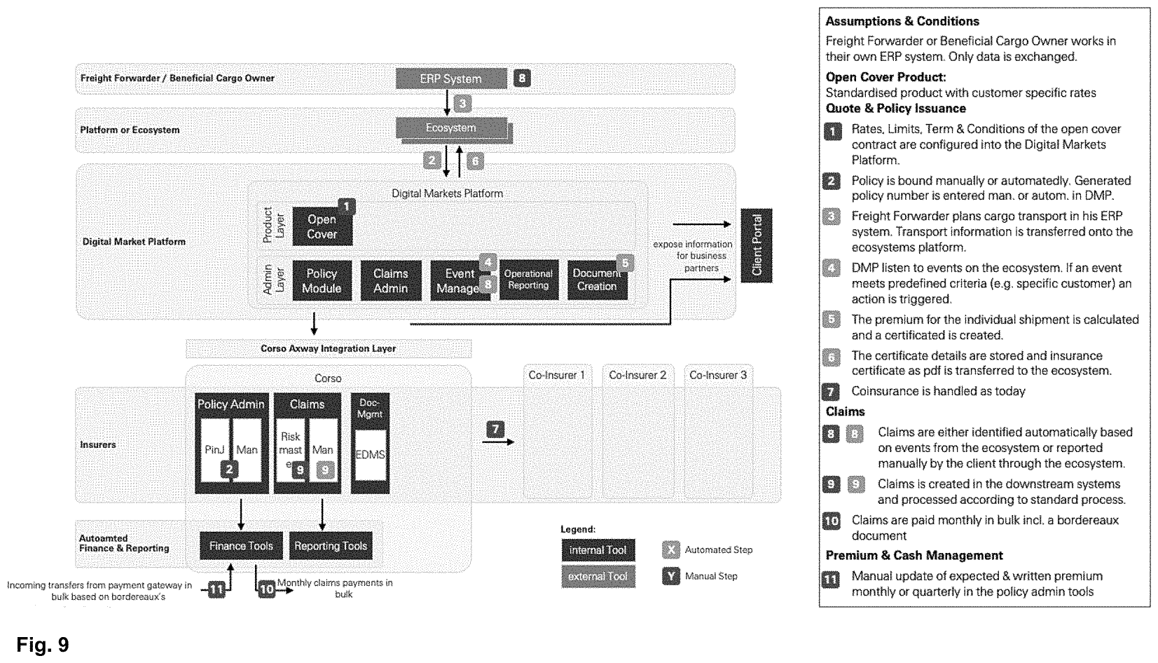

FIG. 9 shows an example of a block diagram which schematically illustrates a structure and architecture of an intermediary, digital, event-driven platform 1 for a digital market as a parametric insurance platform, as shown in FIG. 3, in an embodiment adapted to marine cargo risk sources or risk events 10i11.

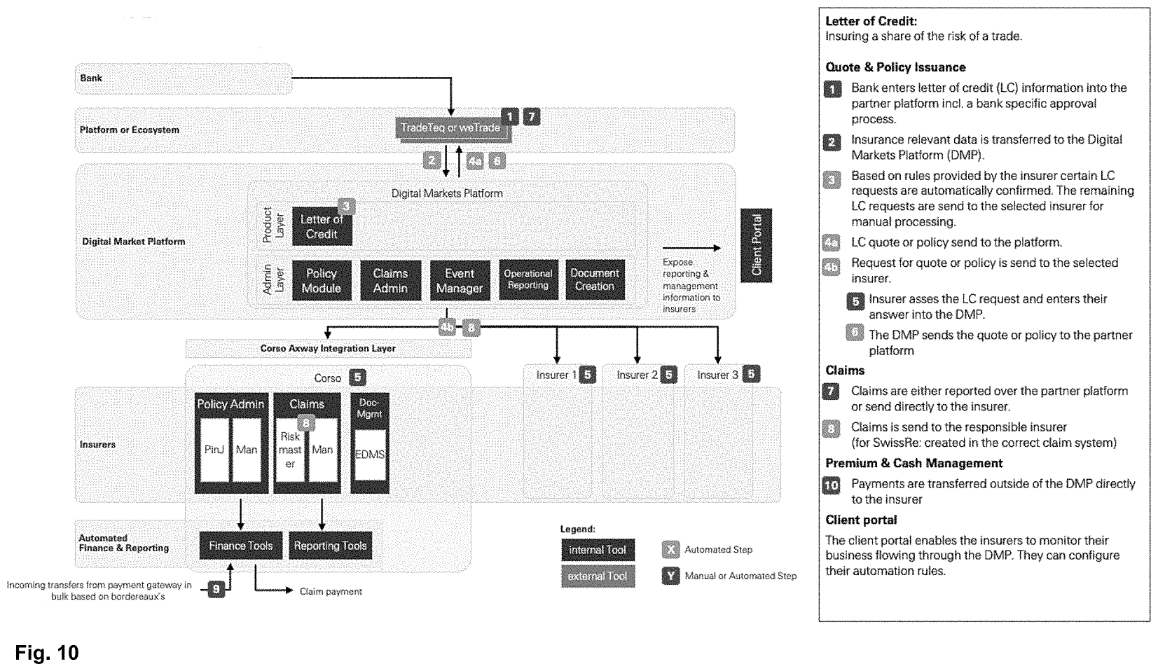

FIG. 10 shows an example of a block diagram which schematically illustrates a structure and architecture of an intermediary, digital, event-driven platform 1 for a digital market as a parametric insurance platform, as shown in FIG. 3, in an embodiment adapted to trade finance risk sources or risk events 10i11.

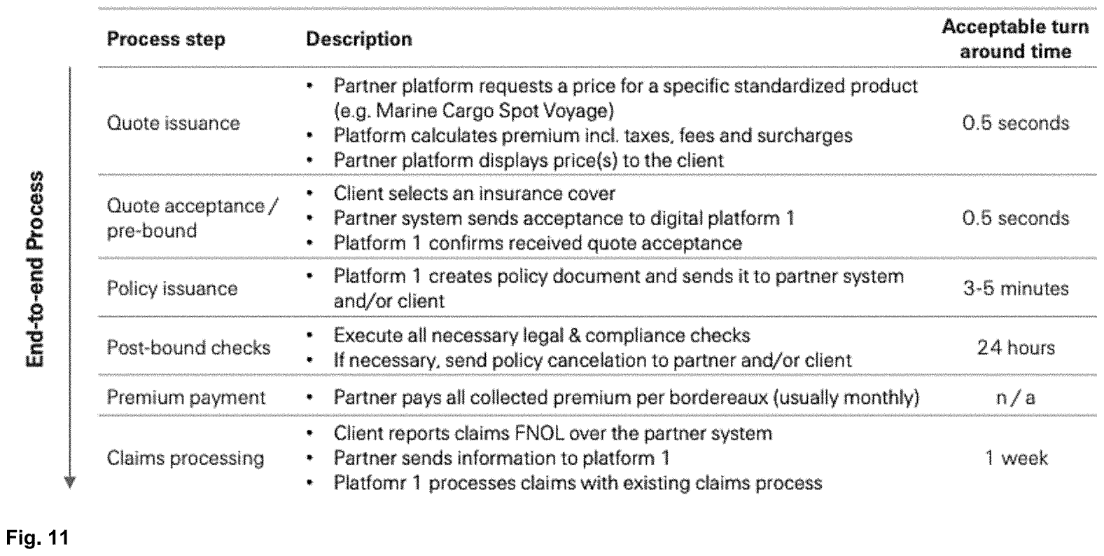

FIG. 11 shows an example of a block diagram which schematically shows the standardised process steps of risk transfer design or provision by means of the intermediary, digital platform 1 in an embodiment adapted to marine cargo risk sources or risk events 10i11. The platform 1 provides standardised risk transfers for marine cargo risks, which can be offered as an additional service via partner platforms. These partner platforms can, for example, carry out or organise the worldwide shipping of goods and bring together freight owners, shipping companies and forwarding agents as participants in this specific industrial ecosystem. Marine cargo is a fast, highly transaction-oriented service that runs around the clock, which is why this branch of industry also needs a platform 1 like the present inventive digital system 1 that has the ability to create risk transfers quickly and as automatically as possible around the clock. FIG. 11 in particular shows the preferred point in time in the process with marine cargo-related services at which the respective controls and tests should be carried out. Depending on the application, the various checks may also need to be performed at an earlier stage in the process. The checks can include, for example, Know Your Client (KYC) checks, such as in particular (i) Licence and Permanent Establishment (LPE) (checked during the processing step of “quote insurance/quote risk-transfer”), (ii) Anti Money Laundry (AML) (post-bound check, where “post-bound” means “here after confirmation of insurance cover”. It can be part of the policy that it becomes void if the checks are not positive), (iii) International Trade Controls (ITC) (post-bound check), (iv) Sustainable Business Risk (SBR) (post-bound check). In general, whether these tests can be carried out by the digital system 1 after binding or whether they must be carried out before binding depends on the respective conditions.

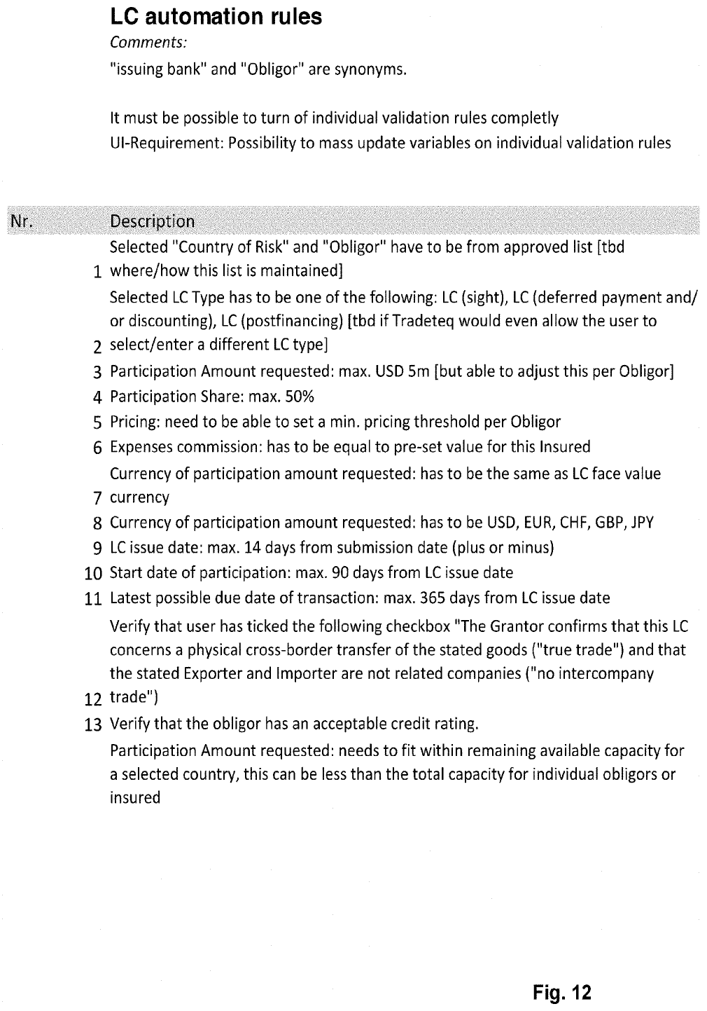

FIG. 12 shows an example of a block diagram that schematically shows the standardised rule-based process steps (LC automation rules) for the automated checking of the letter of credit (guarantee or Letter of Credit (LC)), which guarantees the payment transfer from the buyer to the seller. This is typically issued by a bank and ensures timely and full payment to the seller. If the buyer is unable to make such a payment, the bank assumes all or the remaining amount on behalf of the buyer and the risk taker, i.e. the insurance of the risk transfer system, pays part of the damage.

### DETAILED DESCRIPTION OF PREFERRED EMBODIMENTS

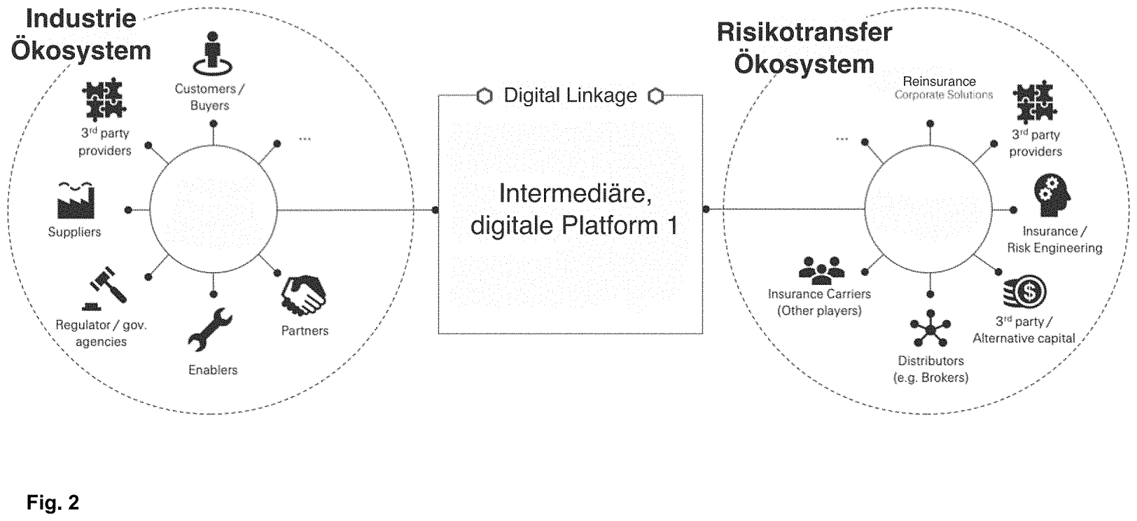

The invention forms an intermediary, digital, data-driven platform 1 for industrial ecosystems for quantitative recording, standardised provision and automated management of risk transfers. The digital platform 1 can in particular act as an automated risk transfer orchstrator between the heterogeneous risks of the industrial ecosystem and the different structures of the providers in the risk transfer ecosystem (see, inter alia, FIG. 2). The digital platform offers (i) insights into risks: it offers partners and customers automated risk management services as well as standard and non-standard risk transfer covers; (ii) digital service options: maintenance and management of insurance contracts with open standards (policy issuance, certificates, claims, etc.); and (iii) insurance orchestration: risk transfer to multiple insurance carriers, orchestrated by the digital platform 1. The inventive solution is designed in such a way that it makes it possible to become the exclusive risk transfer partner for risk coverage in heterogeneous industrial ecosystems by providing digital, data-driven risk transfer structures via the standardised platform and thereby acting as a risk transfer orchestrator, in particular for a large number of risk carriers.

As an embodiment, the inventive digital platform 1 can be in a position to offer services in different categories, e.g. in the five categories (verticals), such as: (i) logistics: spot cover as a standard insurance that is offered to every participant in the market platform, and open cover as a pre-agreed framework agreement with a specific participant in the market platform; (ii) aviation: event coverage against flight delays and extended warranties for airlines based on framework agreements; (iii) trade credits: orchestrated trade credit insurance between multiple insurers; (iv) machinery and equipment: event-driven insurance protection against unexpected machine failures for manufacturers based on framework agreements; and (v) parametrics: parametric coverage against Nat-Cat (natural catastrophe events) for companies or individuals. In particular, the invention offers automated, rule-based capabilities and functionalities that cover the entire risk transfer process and the value chain.

As FIG. 3 shows, the automation rules are both category-specific (vertical-specific) and the data parameter set required for a solution. Machine learning can be used to automate risk transfer quotation/pricing automation, wherein pricing depends on the likelihood that the pricing is correct. The rule-based automation makes the invention scalable within its category (here: logistics, aviation, trade credits, machinery and equipment and parametrics).

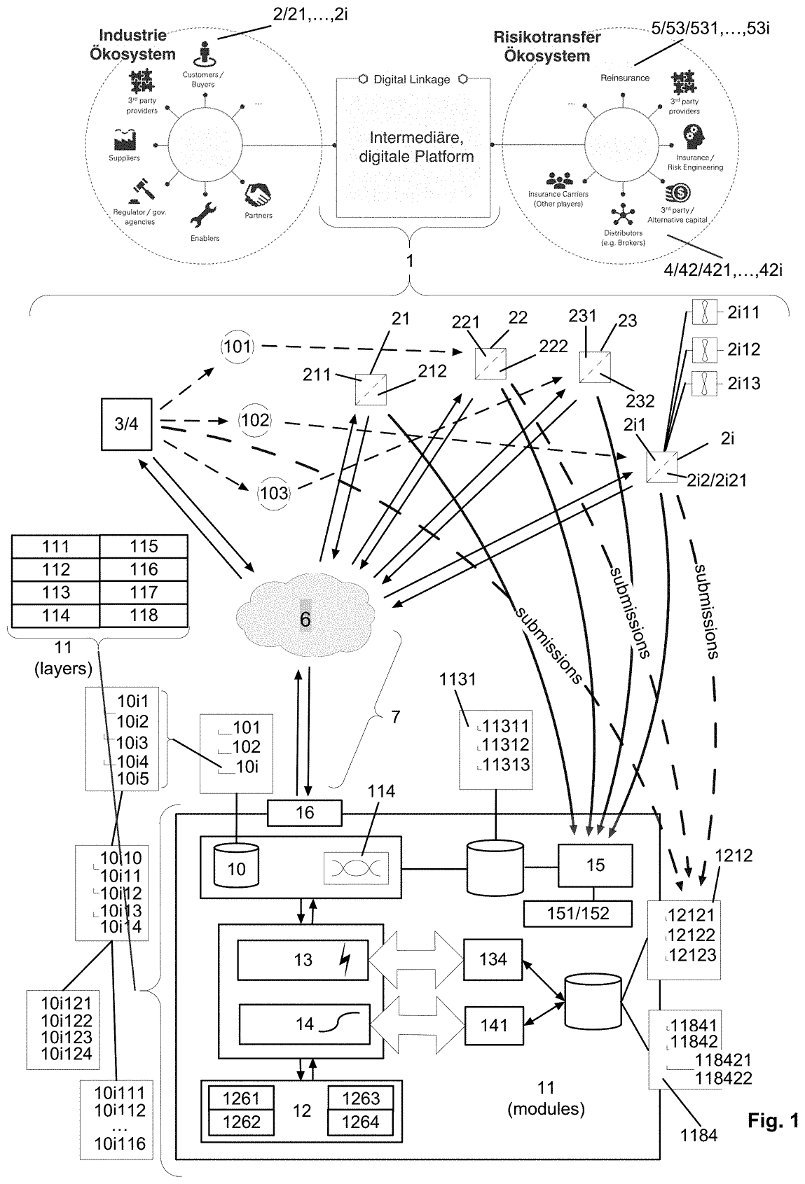

FIG. 1 shows a general structure for realising an intermediary, digital, event-driven platform 1 for scalable, standardised provision, implementation, and management of risk transfers 10i1 of a large number of risk transfer systems 42/421, . . . , 42i and for covering effects on event-exposed units 2/21, . . . , 2i, caused by defined future occurring, physical events as a source of risk 10i11 according to the invention. The probability of the future occurrence of one of the defined physical events 10i11 comprises heterogeneous risk classes 118012 and risk segments 118013. As a standardised digital channel, the intermediary platform 1 links the event-exposed units 2/21, . . . , 2i and the risk transfer systems 42/421, . . . , 42i by means of the risk transfers 10i1. The heterogeneous risk classes 118012 and risk segments 118013 can, for example, include at least maritime-based risk events 10i111 and/or aviation-based risk events 10i112 and/or trade finance-based risk events 10i113 and/or industrial IoT-based risk events 10i114 and/or logistics-related risk events 10i115 and/or parametric coverage of natural catastrophe events 10i116.

Using the digital platform 1, the risk transfers 101, 102, . . . , 10i with assigned risk transfer parameters 10i1 and assigned premium parameters 10i4 for the heterogeneous risk classes 118012 and risk segments 118013 are provided in a standardised manner based on recorded user- or exposure-specific data. They are assigned to a portfolio as risk transfer portfolio data 101, 102, . . . , 10i in a persistence memory 10 of the digital platform 1. The risk transfer portfolio data 101, 102, . . . , 10i of a risk transfer 10i1 comprise at least one assigned link between a risk source 10i11, a risk exposure measure 10i12, and an event-exposed asset 10i13 of an event-exposed unit 10i10/2, 21, 22, . . . , 2i. Based on the assigned premium parameters premiums 10i4, they are transferred to the digital platform 1 or the risk transfer systems 10i14/42/421, . . . , 42i to carry out the risk transfer 10i1. The measured risk exposure measure 10i12 can, for example, be determined based on the measured and/or predicted probability of occurrence 10i121 with assigned event strength 10i122 and transmission strength 10i123 for a defined future time window as a function of time.

When one of the defined events 10i11 and one of the effects 10i12 that can be assigned to the event 10i11 occur on one of the event-exposed assets 10i13 of the risk transfer portfolio data 101, 102, . . . , 10i, damage parameters 10i5 are recorded in a standardised manner by means of the digital platform 1, wherein, by means of the recorded damage parameter 10i5, a damage coverage for effects 10i12 generated by the occurring defined event 10i11 based on the risk transfer parameters 10i1 is triggered automatically by means of the system 1 and is transmitted to the event-exposed unit 10i10.

The digital, event-driven platform 1 can, for example, be implemented at least based on a triple layer structure, wherein the digital platform 1 comprises a product layer 111 for the automated configuration and generation of a risk transfer 1111, 1112, 1113, 1114, . . . , 111i with product-specific capacities 1110, an administration layer 112 for managing and assigning company-specific capacities 1126 and an infrastructure layer 113 for providing digital platform functionalities 1131, as a platform-layer structure 11. The capacities 1126 can, for example, comprise or designate encapsulated and independently constructed process and system functionalities. The encapsulated and independently constructed process and system functionalities of the capacities 1126 can comprise, for example, defined input parameters and defined output parameters.

By means of the product layer 111, for example, a risk transfer 1111, 1112, 1113, 1114, . . . , 111i can be automatically generated and/or configured at least based on rate tables. As an alternative design variant, for example, a risk transfer 1111, 1112, 1113, 1114, . . . , 111i can be dynamically generated and/or configured by means of the product layer 111. The capacities 1110 can be generated product-specifically by means of the product layer 111, for example. The product-specific capacities 1110 can comprise at least product-specific process functionalities 11101 and/or product-specific system functionalities 11102, for example. The capacities 1126 can be generated company-specifically by means of the administration layer 112, for example. The company-specific capacities 1126 can comprise at least company-specific process functionalities 11261 and/or company-specific system functionalities 11262, for example. The administration layer 112 can comprise, for example, at least one policy module 1121 and/or a claims administration module 1122 and/or an operational reporting module 1123 and/or an event manager module 1124 and/or a placing platform 1125. The digital platform functionalities 1131 can comprise at least digital security functions 11311 and/or a digital monitoring unit/monitoring 11312, for example. The digital platform 1 can, for example, comprise a workflow engine 114 for configuring and executing a processing process for individual use cases in the workflow engine 114 using the capacities 1110/1126 built up by means of the products layer 111 and administration layer 112. The digital platform 1 can, for example, further comprise a jointly accessible API integration layer 115 for company-specific backend applications 1151. The digital platform 1 can furthermore also comprise a standardisation layer 116. By means of the standardisation layer 116, it is possible, for example, to transfer and/or translate external data records in standard data structures 1161 of the digital platform 1. The re-usability of the capacities 1126 can be provided by means of the standard data structures 1161, for example.

The digital, event-driven platform 1 can advantageously also comprise, for example, a risk insights module 118 for providing risk management services for standard and non-standard risk transfer covers for partners and customers (carriers) and/or insured persons, in particular using the portfolio manager module 12. The digital platform can, for example, comprise a scenario-based risk processor 1186 and/or prediction engine 1185, which links every possible combination of location, activities and attributes with at least one of the predefined scenarios stored in a scenario database, wherein a scenario-based score is assigned to each possible combination. Based on the risk scoring, a risk insight or risk advice can, for example, be created automatically, which contains a description of the scenario and/or its relevance and/or possible prevention mechanisms that can be carried out by the unit 21, 22, . . . , 2i. The risk scoring can, for example, provide measured values and insights about the danger. For example, the risk insights module 118 can interpret the results for the end user 10i14 for each asset 10i13 and each risk 10i11. As an expert system, for example, it may be able to provide answers to the following questions: (i) What is it?; (ii) What can happen?, (iii) What can be done about it? Scenarios are available for every possible combination of location, activities and attributes. Depending on the number of points, for example, the corresponding scenario can be displayed. The scenarios use examples to explain why a particular risk is at the forefront. In this way, the company immediately understands why a certain risk is more critical than another. The company can also learn, for example, how it can mitigate such risks and make its business processes more secure.

The digital event-driven platform 1 can, for example, additionally comprise an automated underwriting and pricing module 13, in which basic tariffs for applicable risk transfer cover are provided and corresponding prices are generated on the basis of the basic tariffs, associated tariff factors and value parameters of the asset characteristic parameters. Based on the corresponding relationship between a risk source 11842, a risk measure 11852 and a risk-exposed asset, for example, various applicable risk transfer covers can be generated and assigned to a profile of the risk-exposed unit 21, 22, . . . , 2i. For example, the digital platform of the system 1 can comprise a prediction engine 1185 for the automated prediction of predictive risk-exposure measurement parameters 11852 based on event parameter values 118421 of time-dependent series of events of physical risk events 11842. In this case, the occurrence of the physical risk events 11842 can be measured based on predefined threshold values of the event parameters 118421, and the effects of physical risk events 11842 on a defined asset can be measured based on risk-exposure measurement parameters 11852 associated with the asset. To capture the risk event parameters 118421, the prediction engine 1185 can comprise, for example, machine-based exposure data intelligence 11853 that is capable of automatically identifying risks of assets based on at least one location of the asset.

A risk score 11824 can, for example, be generated by the risk insights module 118 and assigned to each profile segment 11823 of the risk profile 1182. An interactive portfolio control and/or management can, for example, take place by interactive assignment and adaptation of risk transfer coverages to the risk transfer portfolio 101, 102, . . . , 10i by a unit 21, 22, . . . , 2i assigned to the portfolio 101, 102, . . . , 10i. The interactive portfolio control can, for example, also take place by interactive assignment and adaptation of risk transfer coverages to the risk transfer portfolio 101, 102, . . . , 10i by a broker unit instead of the risk-exposed unit 21, 22, . . . , 2i, which represents a risk-exposed unit 21, 22, . . . , 2i associated with the portfolio 101, 102, . . . , 10i.

The risk insights module 118 or a complementary advisory module 14 of the digital platform 1 can, for example, provide the unit 21, 22, . . . , 2i associated with the risk profile 1182 with a customised advisory visualisation of the risk profile 1182 through actionable, tangible and data-driven insights on risk transfer. The digital platform 1 can furthermore comprise a graphical user interface (GUI), which is provided by the risk insights module 118, in order to generate a dynamic representation of a portfolio structure. By means of the prediction engine 1185, the dynamic representation of the portfolio structure 101, 102, . . . , 10i can, for example, provide a user or a unit 2/3 with predictive insights and thus portfolio control by identifying critical areas and/or sections of a portfolio 101, 102, . . . , 10i and a risk profile 1182 and the effects of possible changes in the risk exposure of the corresponding profile sections or profile segments. The machine exposure data intelligence 1153 can, for example, evaluate the exposure database 1184, which comprises a large number of data sets with attribute parameters of assets/objects 1183 at least with assigned geographic location parameters. The machine exposure data intelligence 1153 may further comprise a cluster module for clustering stored assets 10i13 of the exposure database 1184 with respect to their allocated geographic location parameters, and wherein different data sets of the exposure database 1184 are matched with the same or close geographic location parameters and the risk burdens of a defined asset 10i13 of a unit 2i can be compared with the risk exposure of the data sets with the same or close geographical location parameters.

The digital platform 1 can, for example, comprise a portfolio manager module 12 that provides the segmentation 1261, the classification 1262, the measurement of risk exposure and/or the risk scoring 1263 and the interactive control of the exposure 1264 of risk pools. A risk pool can comprise a large number of asset/object classes 11822 of a risk-exposed unit 21, 22, . . . , 2i, wherein the asset/object classes 11822 are assigned to at least one risk exposure that is induced by buildings and/or equipment and/or goods/services and/or customers and/or employees and/or digital/IP assets and/or vehicle fleet. In a variant, the digital platform 1 can also comprise a portfolio management module 12 which provides the segmentation 1261, the classification 1262, the measurement of risk exposure and/or risk scoring 1263 and the interactive control of the exposure 1264 of large risk pools. The risk pool can comprise a large number of risk types 118012 of a risk-exposed unit 21, 22, . . . , 2i, wherein the risk types 1141 are associated with at least fire events and/or flood events and/or hail or storm events and/or fraud events and/or employee illness events and/or building failure events and/or business interruption events and/or burglary events and/or product liability events and/or cyber attack events and/or natural catastrophe events in general. The use and access to the digital platform 1 can be designed more user-friendly, for example, by realising the device interfaces accessible via the interface 16, for example, as a web application, which enables the user to access the digital platform 1, for example, via the global backbone network Internet. The web app can be realised using an API with appropriate http request and response processes.

### LIST OF REFERENCE NUMERALS

1 automated digital market platform
   10 persistence storage comprising portfolio data
      101, 102, . . . , 10i risk transfer portfolio data
         10i1 link/risk transfer
            10i10 risk-exposed unit
            10i11 risk source/risk event
            10i111 maritime cargo risk events
            10i112 aviation-based risk events
            10i113 trade finance risk events
            10i114 industrial IoT risk events (IIoT)
            10i115 logistics-related risk events
            10i116 parametric coverage of natural catastrophe events
            i12 risk exposure and risk exposure measurement parameter
            10i121 probability of occurrence
            10i122 event strength
            10i123 impact measure (transfer strength)
            10i124 forecast time window
            10i13 assets of the risk-exposed unit
            10i14 risk carrier (risk transfer system 42/421, . . . , 42i)
         10i2 submission of the risk-exposed unit of portfolio 10i
         10i3 portfolio 10i assigned risk-exposed unit
         10i4 premium parameter (pricing)
         10i5 damage parameter
   11 digital platform layers and units
      111 product layer
         1110 assigned product-specific capacities
            11101 product-specific process functionalities
            11102 product-specific system functionalities
         1111, 1112, 1113, 1114, . . . , 111i risk transfer i/product i
      112 administration layer
         1121 policy module
         1122 claims administration module
         1123 operational reporting module
         1124 event manager
         1125 placing platform/interface
         1126 assignable company-specific capacities
            11261 company-specific process functionalities
            11262 company-specific system functionalities
      113 infrastructure layer
         1131 digital platform functionalities
            11311 digital security functions
            11312 digital monitoring unit
      114 workflow engine
      115 Application Programming Interface (API) integration layer
         1151 company-specific backend applications
      116 standardisation layer
         1161 standard data structures
      117 client portal
      118 risk insights module
         1180 automated parameter indexing module
            11801 index data structure
            118011 event-exposed unit
            118012 risk classes
            118013 risk segments
            118014 location
            118015 activities
            118016 attributes
            . . .
            11802 data aggregator
            11803 machine-based exposure data intelligence
         1181 database with risk profiles
         1182 risk profile of the database 1181
            11821 characteristic parameter
            11822 asset/object classes of the assets/objects
            11823 profile segment
            118231 asset of the profile segment
            118232 exposure segment
            11824 risk score for each of the profile segments
            11825 risk exposure of a specific asset of the unit 2i
         1183 asset/object classifier
            11831 asset/object class database
            118311, . . . , 11831i asset/object classes
            11832 matching structure
         1184 exposure database
            11841 risk types/classes
            11842 risk sources/risk events
            118421 historic event parameter
            118422 predicted event parameter
         1185 predictive engine (risk scoring)
            11850 probability of occurrence of risk events
            11851 impact measurement parameter
            11852 risk exposure measurement parameter
            11853 machine-based exposure data intelligence
         1186 scenario-based risk processor
   12 portfolio manager module
      121 access controller
         1211 risk-exposed unit/broker unit access interface
         1212 submission database
            12121 submission data of unit 21
            12122 submission data of unit 22
            . . .
            1212i submission data of unit 23
         1213 submission analyser
      122 portfolio analyser
      123 collaboration module
      124 document management module
      125 visualisation module
      126 portfolio manager processes
         1261 segmentation
         1262 classification
         1263 risk exposure measurement/risk scoring
         1264 interactive exposure control and management
   13 underwriting and pricing module
      131 communications database
      132 profile database with the accounts of the risk-exposed units
         1321 profiles of the risk-exposed units
      133 profile database with the accounts of partners and brokers
         1331 profiles of partner and broker units
      134 quote module
         1341 quote engine
            13411 available/possible risk transfers
            13412 basic tariffs/basic rates
            13413 rate factors
            13414 pricing
         1342 quote server interface
      135 billing/accounting module
   14 complementary advisory module
      141 customised advisory visualisation
   15 web server
      151 firewall
      152 router
   16 network interface
   2 risk-exposed units (entities)/customers/buyers
   20 customer tools
   21, 22, . . . , 2i risk-exposed units
      2i1 assets of the risk-exposed units
         2i11, . . . , 2i1x associated with the asset 2i1
            Data recording, measurement devices and measurement sensors
      2i2 network-compatible devices and tools of the unit 2i
         2i21 network interface
   3 external platforms and ecosystems/broker units
   31 digital markets
   32, 33, . . . , 3i external platforms and broker units
      3i1 network-compatible external and broker tools
         3i11 network interface
   4 primary insurance/business partners
   41 company-specific solutions (corporate solutions)/client tools
      411 policy administration module
      412 claims handling module
      413 partner management module
      414 document management module
   42 first tier risk transfer systems
      421 risk transfer system 1
      422 risk transfer system 2
      423 risk transfer system 3
   5 reinsurance
   51 financing tools
   52 reporting tools
   53 first tier risk transfer systems
      531 risk transfer system 1
      532 risk transfer system 2
      533 risk transfer system 3
   6 data transfer network
   61 worldwide backbone network internet
   7 secure cloud-based network
   71, 72, . . . , 7i dedicated secure network
      7i1 controlled cloud-based network access to the secure network 7i

1. A system for scalable, standardised provision, implementation, and management of risk transfers of a plurality of risk transfer systems to cover effects on event-exposed units caused by defined, future occurring, physical events as a risk source, where a probability of a future occurrence of one of the defined physical events comprises heterogeneous risk classes and risk segments, the system comprising:
a processor-driven intermediary, digital, event-driven platform, wherein
the platform links, as a standardised digital channel, the event-exposed units and the risk transfer systems by the risk transfers,
the platform provides, in a standardised manner, the risk transfers with assigned risk transfer parameters and assigned premium parameters for the heterogeneous risk classes and the risk segments based on recorded user- or exposure-specific data and stores the risk transfers with the assigned risk transfer parameters and the assigned premium parameters as risk transfer portfolio data assigned to a portfolio in a persistence memory,
the risk transfer portfolio data of each of the risk transfers includes at least one allocated link between a risk source, a risk exposure measure, and an event-exposed asset of an event-exposed unit,
based on the assigned premium parameters, premiums are transferred to the platform or the risk transfer systems for carrying out the risk transfers,
when one of the defined physical events and one of the effects that can be assigned to the one of the defined physical events occurs on one of the event-exposed assets of the risk transfer portfolio data, the platform records, in a standardised manner, damage parameters, and
the platform automatically triggers and transfers, to the event-exposed unit, a damage coverage for effects generated by the occurring defined physical event based on the risk transfer parameters and the recorded damage parameters.

2. The system according to claim 1, wherein the risk exposure measure is determined based on a measured and/or forecasted probability of occurrence with an assigned event strength and a transmission strength for a defined future time window as a function of time.

3. The system according to claim 1, wherein the platform is realised at least based on a triple layer structure including a product layer for automated configuration and generation of a risk transfer with product-specific capacities, an administration layer for management and assignment of company-specific capacities, and an infrastructure layer for providing digital platform functionalities.

4. The system according to claim 3, wherein the risk transfer is at least automatically generated and/or configured based on rate tables via the product layer.

5. The system according to claim 3, wherein the risk transfer is dynamically generated and/or configured via the product layer.

6. The system according to claim 3, wherein the product-specific capacities are generated product-specifically via the product layer.

7. The system according to claim 6, wherein the product-specific capacities include at least product-specific process functionalities and/or product-specific system functionalities.

8. The system according to claim 3, wherein the company-specific capacities are generated company-specifically via the administration layer.

9. The system according to claim 8, wherein the company-specific capacities include at least company-specific process functionalities and/or company-specific system functionalities.

10. The system according to claim 3, wherein the administration layer includes at least one policy module and/or a claims administration module and/or an operational reporting module and/or an event manager module and/or a placing platform.

11. The system according to claim 3, wherein the digital platform functionalities include at least digital security functions and/or a digital monitoring functions.

12. The system according to claim 3, wherein the platform includes a workflow engine for configuring and executing a processing process for individual applications in the workflow engine using the product-specific capacities and the company-specific capacities developed via the product layer and the administration layer.

13. The system according to claim 3, wherein the digital platform includes a jointly accessible API integration layer for company-specific backend applications.

14. The system according to claim 3, wherein
the digital platform includes a standardisation layer,
external data sets are transferable and/or translatable in standard data structures of the digital platform via the standardisation layer, and
re-usability of the company-specific capacities is provided via the standard data structures.

15. The system according to claim 3, wherein the company-specific capacities include encapsulated and independently developed process and system functionalities.

16. The system according to claim 15, wherein the encapsulated and independently developed process and system functionalities of the company-specific capacities include defined input parameters and defined output parameters.

17. The system according to claim 1, wherein the heterogeneous risk classes and the risk segments include at least one of:
maritime-based risk events,
aviation-based risk events,
trade finance-based risk events,
Industrial IoT-based risk events,
logistics-related risk events, and
parametric coverage of natural catastrophe events.
